(19) United States
(12) Patent Application Publication
(10) Pub. No.: US 2025/0303922 A1
(43) Pub. Date: Oct. 2, 2025

(54) CONTROL APPARATUS FOR SECONDARY BATTERY

(71) Applicant: Mazda Motor Corporation, Aki-gun (JP)

(72) Inventors: Takashi Yamamoto, Aki-gun (JP); Yuto Yamada, Aki-gun (JP)

(21) Appl. No.: 19/052,640

(22) Filed: Feb. 13, 2025

(30) Foreign Application Priority Data
Mar. 26, 2024 (JP) 2024-050454

(51) Int. Cl. B60L 58/13; B60L 58/16; B60L 58/18; H01M 4/02; H01M 4/48; H01M 10/42; H01M 10/44; H01M 50/249

(52) U.S. Cl. CPC B60L 58/13; B60L 58/16; B60L 58/18; H01M 4/48; H01M 10/425; H01M 10/441; H01M 50/249; B60L 2250/00; H01M 2004/027; H01M 2220/20

(57) ABSTRACT

To restrain performance deterioration of a secondary battery caused by peeling-off of a negative electrode active material, a control apparatus for a secondary battery includes a state of charge (SOC) sensor and a controller. The controller determines whether or not, for at least one of a plurality of battery modules, an SOC is not less than a predetermined first reference value, and when the SOC is not less than the first reference value, performs a first control of connecting the plurality of battery modules one by one to a motor and causing the plurality of battery modules to discharge one by one until the SOC of each battery module has decreased to the first reference value.

### TECHNICAL FIELD

The present disclosure relates to a control apparatus for a secondary battery.

### BACKGROUND ART

For example, JP2023-134205A discloses a negative electrode active material for lithium-ion batteries that contains Si. The negative electrode active material includes a Si-containing granulated material in which Si alloy or pure Si and a particulate carbon material are compounded. According to JP2023-134205A, using Si for the negative electrode can enhance the discharge capacity of a lithium-ion battery.

### SUMMARY OF INVENTION

### Problem to be Solved by the Invention

Nevertheless, there is a possibility that the negative electrode active material as disclosed in JP2023-134205A above is peeled off from a current collector due to repetition of expansion and contraction with charge and discharge. This is disadvantageous since such peeling-off of the negative electrode active material causes the function of the negative electrode to be impaired.

The present disclosure has been devised in view of such circumstances, and an object thereof is to restrain performance deterioration of a secondary battery caused by peeling-off of a negative electrode active material.

### Means for Solving the Problem

A first aspect of the present disclosure relates to a control apparatus for a secondary battery, the secondary battery including a plurality of battery modules each including one or more battery cells and connected to a driving source of a vehicle, the one or more battery cells each having a negative electrode including a negative electrode active material, the control apparatus supplying electric power to the driving source from the plurality of battery modules.

According to the first aspect, the control apparatus includes: a state of charge (SOC) sensor that detects a parameter indicating an SOC of each of the plurality of battery modules; and a controller that switches electric connections between the plurality of battery modules and the driving source based on a detection signal of the SOC sensor, and the controller is configured to, based on the detection signal of the SOC sensor, determine whether or not, for at least one of the plurality of battery modules, the SOC is not less than a predetermined first reference value, and when the SOC is not less than the first reference value, perform a first control of connecting the plurality of battery modules one by one to the driving source and causing the plurality of battery modules to discharge one by one until the SOC of each battery module has decreased to the first reference value.

Herein, the term “parameter indicating the SOC” is used in a broad sense. This parameter may be the SOC itself or may be a parameter that is changing in response to increase and decrease of the SOC, such as a current charge amount of the secondary battery. Also as a parameter to be compared with the first reference value, another parameter such as the current charge amount may be used in place of the SOC. Namely, the “case where the SOC is not less than the first reference value” may be a case where the SOC and the first reference value are directly compared, or may be a case where the SOC and the first reference value are indirectly compared, such as a case where the parameter indicating the SOC and the first reference value are compared.

According to the first aspect, the controller performs the first control when the SOC is not less than the first reference value. Performing the first control can keep the number of the battery cells as targets of charge and discharge as few as possible, as compared with the case where the plurality of battery modules are connected in parallel. This can restrain a frequency of expansion and contraction occurring in the battery cells caused by the intercalation reaction and/or the like, and restrain performance deterioration of the secondary battery caused by peeling-off of the negative electrode active material.

Moreover, in the case where discharge depths of the battery cells are deep, such as the case where the SOC is less than the first reference value, there arises concern of performance deterioration other than that of the peeling-off, rather, caused by the C-rate taking a high rate. Therefore, under conditions where such concern is supposed, the controller does not perform the first control. This is significantly advantageous to restraining the performance deterioration of the secondary battery.

Moreover, according to a second aspect, the controller may be further configured to, based on the detection signal of the SOC sensor, determine whether or not, for all of the plurality of battery modules, the SOC is less than the first reference value, and when the SOC is less than the first reference value, perform a second control of connecting the plurality of battery modules to the driving source in parallel and simultaneously causing the plurality of battery modules to discharge.

According to the second aspect, when the discharge depths of the battery cells become deep, the plurality of battery modules are connected to the driving source in parallel. This can restrain the C-rate per battery module, and consequently, per battery cell, and is advantageous to restraining the performance deterioration of the secondary battery. By switching the electric connections in accordance with the SOCs, the performance deterioration of the secondary battery can be restrained as much as possible.

Moreover, according to a third aspect of the present disclosure, the controller may be further configured to, based on a setting input by an occupant of the vehicle, select one discharge mode out of a plurality of discharge modes that are set to correspond to the electric connections, and select and perform one of the first control and the second control based on the detection signal of the SOC sensor so as to attain the selected one discharge mode, and the plurality of discharge modes may include a first mode of continuing the first control regardless of the detection signal of the SOC sensor by allowing discharge within an SOC range of which the first reference value is a lower limit, and a second mode of properly using the first control and the second control in accordance with the detection signal of the SOC sensor by allowing discharge within an SOC range of which a second reference value is a lower limit, the second reference value being set to be less than the first reference value.

According to the third aspect, since the first reference value is the lower limit, the first mode results in a shorter travelable distance than the second mode, but is also more effective in restraining the performance deterioration of the secondary battery than the second mode. The first mode and the second mode are unable to lengthen both the travelable distance and the service life of the secondary battery, but are rather configured to give priority to one of these effects. The occupant can drive the vehicle in the first mode or drive the vehicle in the second mode.

As above, by employing a configuration of leading the occupant to select one of the first mode and the second mode without being fixed to the first mode or the second, flexible discharge control can be attained in accordance with a preference of the occupant, a situation of the occupant, and the like. This can improve usability of the vehicle.

Moreover, according to a fourth aspect of the present disclosure, after the driving source is started, the controller may be further configured to notify the occupant of first information including a first distance indicating a travelable distance of the vehicle in the first mode, a second distance indicating a travelable distance of the vehicle in the second mode, a first deterioration index indicating a degree of deterioration of a maximum capacity of the secondary battery after traveling the first distance, and a second deterioration index indicating the degree of deterioration after traveling the second distance. The controller may be configured to accept selection of the first mode or the second mode based on the setting input of the occupant.

According to the fourth aspect, by notifying the occupant of the first information as mentioned above, an advantage of the first mode and an advantage of the second mode can be quantitatively grasped. Thereby, flexible discharge control can be attained in accordance with the preference of the occupant, the situation of the occupant, and the like. This can improve usability of the vehicle.

Moreover, while the second mode which leads to a longer travelable distance tends to be selected when only the first distance and the second distance are displayed, by simultaneously making notification of the first deterioration index and the second deterioration index along with the above parameters, the occupant can be led to grasp the degree of deterioration of the secondary battery quantitatively. This can increase the frequency of selection of the first mode, and is advantageous to restraining the performance deterioration of the secondary battery.

Moreover, according to a fifth aspect of the present disclosure, based on the first deterioration index and the second deterioration index, the controller may be further configured to respectively estimate a first residual value index indicating an economic value of the secondary battery after traveling the first distance and a second residual value index indicating the economic value after traveling the second distance, and the first information may include both the first residual value index and the second residual value index.

According to the fifth aspect, by further making notification of the first residual value index and the second residual value index, the occupant can be led to grasp the degree of deterioration of the secondary battery more appropriately. This can increase the frequency of selection of the first mode, and is advantageous to restraining the performance deterioration of the secondary battery.

Moreover, according to a sixth aspect of the present disclosure, while the vehicle is traveling under selection of the first mode, the controller may be further configured to notify the occupant of second information including a lengthened amount of a travelable distance in a case of switching from the first mode to the second mode and a third deterioration index indicating a degree of deterioration of a maximum capacity of the secondary battery after traveling the lengthened amount, and may be further configured to accept a change from the first mode to the second mode based on the setting input of the occupant.

According to the sixth aspect, the controller accepts the change from the first mode to the second mode even while the vehicle is traveling. Thereby, flexible discharge control can be attained in real time in accordance with a situation of the occupant, and the like. This can improve usability of the vehicle.

Moreover, while the second mode which leads to a longer travelable distance tends to be selected when the change to the second mode is simply accepted, by notifying the occupant of the second information including the third deterioration index, the occupant can be led to grasp the degree of deterioration of the secondary battery quantitatively. This can increase the frequency of continuing the first mode, and is advantageous to restraining the performance deterioration of the secondary battery.

Moreover, according to a seventh aspect of the present disclosure, when a predetermined value that is set to be higher than the first reference value and lower than a fully charged state is set to an intermediate reference value, the controller may be further configured to, based on the detection signal of the SOC sensor, determine whether or not the SOC of the entirety of the plurality of battery modules has decreased to the intermediate reference value, and when the SOC has decreased to the intermediate reference value, may perform notification of the second information.

According to the seventh aspect, the occupant can be notified of the second information at a more appropriate timing. This can improve usability of the vehicle.

Moreover, according to an eighth aspect of the present disclosure, the negative electrode active material may include Si.

It has been recently revealed that the problem of peeling-off as mentioned above is significant when a Si-based active material is used for the negative electrode active material. The configuration as in the first aspect above is particularly effective in the case of using such a Si-containing active material.

### ADVANTAGEOUS EFFECTS OF INVENTION

As described above, according to the present disclosure, gas can be discharged from the inside of the battery cell without causing precipitation of the electrode.

### BRIEF DESCRIPTION OF DRAWINGS

FIG. 1 is a schematic diagram exemplarily showing a vehicle.

FIG. 2 is an exploded view exemplarily showing a configuration of a secondary battery mounted on the vehicle.

FIG. 3A is a perspective view exemplarily showing a configuration of a battery cell.

FIG. 3B is a sectional view exemplarily showing a configuration of the battery cell.

FIG. 4 is a block diagram exemplarily showing a configuration of a control apparatus for a secondary battery.

FIG. 5 is a functional block diagram exemplarily showing a configuration of the control apparatus for a secondary battery.

FIG. 6A is a diagram for explaining a first control.

FIG. 6B is a diagram for explaining the first control.

FIG. 6C is a diagram for explaining the first control.

FIG. 6D is a diagram for explaining a second control.

FIG. 7 is a diagram for explaining the first mode and the second mode.

FIG. 8 is a diagram for explaining first information.

FIG. 9 is a diagram for explaining second information.

FIG. 10A is a flowchart exemplarily showing processing related to selection of the first mode and the second mode.

FIG. 10B is a flowchart exemplarily showing processing related to the second mode.

FIG. 10C is a flowchart exemplarily showing processing related to the first mode.

FIG. 11 is a diagram exemplarily showing a mode selection switch on a touch panel.

FIG. 12-18 are flow charts of a method of operating a control apparatus for a secondary battery, according to one example implementation of the present disclosure.

### MODE FOR CARRYING OUT THE INVENTION

Hereafter, embodiments of the present disclosure will be described based on the drawings. Notably, the following description is an exemplary illustration.

### 1. Overall Configuration

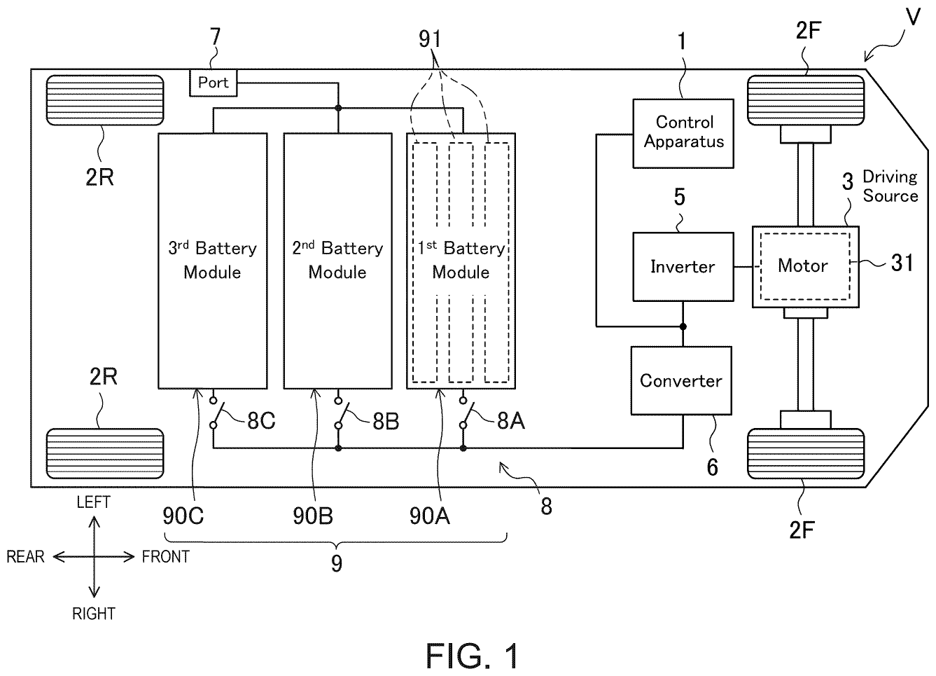

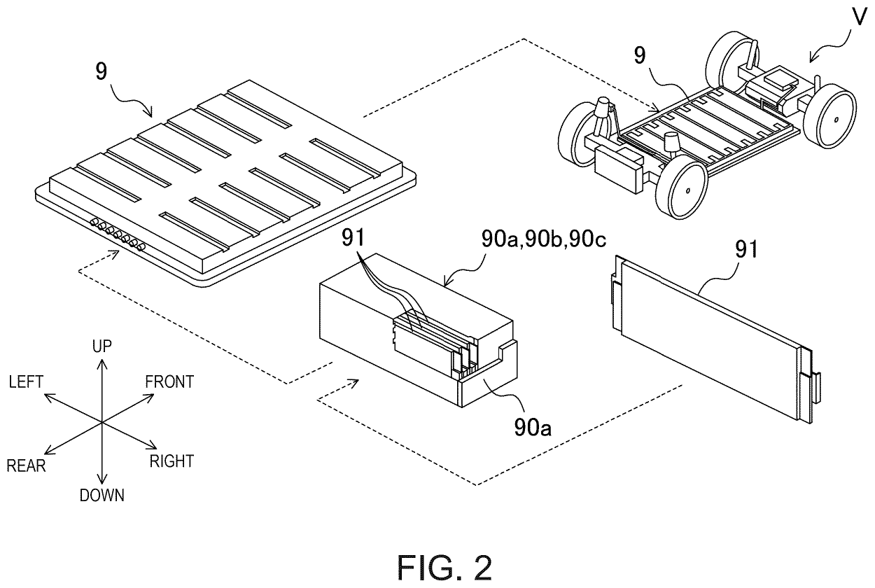

FIG. 1 is a schematic diagram exemplarily showing a vehicle V. FIG. 2 is an exploded view exemplarily showing a configuration of a secondary battery 9 mounted on the vehicle V. A control apparatus 1 for the secondary battery 9 according to the present embodiment is mounted on the vehicle V shown in the figures. The vehicle V is an automobile that can travel using electric power.

Specifically, the vehicle V according to the present embodiment is what is called an electric vehicle (EV). The vehicle V may be a hybrid car with electric power being as a primary energy source, such as a plugin hybrid vehicle (PHEV).

Hereafter, a front-rear direction with reference to the vehicle V, where “front” and “rear” are the directions in which the vehicle V advances and reverses respectively, is called “vehicle front-rear direction” or simply “front-rear direction”. As exemplarily shown in FIG. 1 and FIG. 2, the “front” stated here means a direction where the vehicle V advances, and the “rear” means a direction where the vehicle V reverses (also refer to FIG. 2 mentioned later).

Likewise, a right-left direction with the vehicle body of the vehicle V being as the reference is called “vehicle width direction” or simply “right-left direction”. As exemplarily shown in FIG. 1 and FIG. 2, the “right” stated here means a right side as viewed from an occupant on the vehicle V, and the “left” means a left side as viewed from the occupant.

Likewise, an up-down direction with the vehicle body of the vehicle V being as the reference is called “vehicle height direction” or simply “up-down direction”. As exemplarily shown in FIG. 2, being on the “up” side stated here means being in a direction as viewed from the occupant of the vehicle V, being in a direction that is perpendicular to a road surface on the vehicle V and in which a thing is separating from the road surface. Meanwhile, being on the “down” side stated here means being in a direction as viewed from the occupant of the vehicle V, being in a direction that is perpendicular to the road surface on the vehicle V and in which a thing is coming close to the road surface.

The secondary battery 9 in the present embodiment is configured as a battery system including a plurality of battery modules 90A-C that is to be connected to a driving source 3 of the vehicle V. Herein, as shown in FIG. 1 and FIG. 2, each of the plurality of battery modules 90A-C includes one or more (in the present embodiment, a plurality of) battery cells 91. Furthermore, each of the one or more battery cells 91 has a negative electrode constituted of an active material (negative electrode active material) 92b.

Further, the control apparatus 1 for the secondary battery 9 in the present embodiment means an apparatus that supplies electric power from the plurality of battery modules 90A-C to the driving source 3 of the vehicle V. The control apparatus 1 can be rephrased as a control apparatus/control system that, by supplying electric power to the driving source 3 of the vehicle V, causes the driving source 3 to generate a traveling driving force of the vehicle V.

Specifically, the vehicle V according to the present embodiment includes a plurality of wheels 2F, 2R, a motor 31 being an example constituting the driving source 3, an inverter 5, a converter 6, a charging port 7, a switching circuit 8, the secondary battery 9, and a control apparatus 1, which may include, for example, a controller 100. Each of these elements is mounted or disposed on the vehicle V.

The plurality of wheels 2F, 2R include two front wheels 2F and two rear wheels 2R. Namely, the vehicle V according to the present embodiment is a four-wheeled automobile. The driving source 3 is coupled to all of or part of the plurality of wheels 2F, 2R via shaft(s) and the like.

The driving source 3 is constituted of the motor 31 that can perform a powering operation and a regenerative operation. For example, the motor 31 is a permanent magnet-type synchronous motor that is driven with three-phase alternating current.

In the powering operation, the motor 31 receives electric power supply from the secondary battery 9 to rotate. This rotation generates the traveling driving force of the vehicle V. When the motor 31 rotates in the powering operation, the rotation is transmitted via a not-shown shaft. The rotation transmitted via the shaft rotates at least some of the wheels 2F, 2R, such as the two front wheels 2F. By the at least some of the wheels 2F, 2R rotating, the vehicle V travels.

Moreover, the motor 31 not only functions as a driving source in the powering operation but also can be caused to function as a generator in the regenerative operation. The motor 31 is electrically connected to the secondary battery 9 via the inverter 5 and the converter 6. This connection is used for both the powering operation and the regenerative operation as mentioned below in detail.

In the powering operation, the converter 6 steps down high voltage DC electric power supplied from the secondary battery 9 into DC electric power having a predetermined base voltage.

The converter 6 inputs the DC electric power after the step-down into the inverter 5. The inverter 5 converts the DC electric power supplied from the secondary battery 9 via the converter 6 into three-phase alternating current having phases different from one another. The inverter 5 supplies the alternating current after the conversion to the motor 31. By supplying the alternating current to the motor 31, the motor 31 rotates as mentioned above.

In the regenerative operation, the inverter 5 converts AC electric power generated by rotation of the motor 31 into DC electric power. The inverter 5 inputs the DC electric power after the conversion into the converter 6. The converter 6 boosts the DC electric power input from the motor 31 via the inverter 5. The converter 6 charges the secondary battery 9 with the DC electric power after the boosting.

As mentioned above, the secondary battery 9 includes the plurality of battery modules 90A-C, each of which includes the one or more (in the present embodiment, the plurality of) battery cells 91.

For example, the secondary battery 9 according to the present embodiment includes a first module 90A, a second module 90B, and a third module 90C constituting the plurality of battery modules 90A-C.

Herein, the plurality of battery modules 90A-C according to the present embodiment are lined up one after each other in the front-rear direction as shown in FIG. 1. Each of the battery modules 90A-C lined up in the vehicle front-rear direction has, for example, a length in the battery longitudinal direction (which is the same as the vehicle width direction) that is three times or more a height of the battery in the vehicle height direction (into/out of the page).

Moreover, for example, the plurality of battery modules 90A-C is connected to one motor 31 in parallel. Alternatively, the plurality of battery modules 90A-C may each be individually connected to the motor 31 via converter 6.

Each battery module 90A-C is connected to the charging port 7 via an in-vehicle charger or the like. The charging port 7 can also be rephrased as a charging inlet. To the charging port 7, a connector of power supply equipment can be connected. This connection can supply electric power to the vehicle V from the power supply equipment via the charging port 7.

The switching circuit 8 is configured to switch, by receiving a control signal from the controller 100 to operate, electric connections between the plurality of battery modules 90A-C and the motor 31.

In detail, the switching circuit 8 is set to switch electric connections to the motor 31 individually for the respective battery modules 90A-C. More in detail, the switching circuit 8 performs electrically connecting (relaying, supplying electricity) or disconnecting (separating) between the battery modules 90A-C and the motor 31 individually for the plurality of battery modules 90A-C.

There is hereafter a case where a state where two elements are electrically connected is simply called a “connected state” and a state where they are electrically disconnected is called a “disconnected state”.

For example, in the present embodiment, the switching circuit 8 includes a first switch 8A that switches an electric connection between the first module 90A and the motor 31, a second switch 8B that switches an electric connection between the second module 90B and the motor 31, and a third switch 8C that switches an electric connection between the third module 90C and the motor 31.

Each of the first switch 8A, the second switch 8B, and the third switch 8C may be constituted of a relay circuit that opens and closes a contact in accordance with a control signal received from the controller 100. Each of the switches 8A to 8C constituting the switching circuit 8 switches between the “connected state” and the “disconnected state” based on the control signal received from the controller 100.

For example, by bringing all of the first switch 8A, the second switch 8B, and the third switch 8C into the connected states, the three battery modules 90A-C are to be connected to the motor 31 in parallel.

On the other hand, it is supposed that one of the first switch 8A, the second switch 8B, and the third switch 8C is brought into the connected state and the rest are brought into the disconnected states. In this case, only the one battery module 90A-C that is brought into the connected state is to be connected to the motor 31 and the remaining battery modules 90A-C that are brought into the disconnected states are separated from the motor 31 in an electric manner. <2. Details of Secondary Battery>

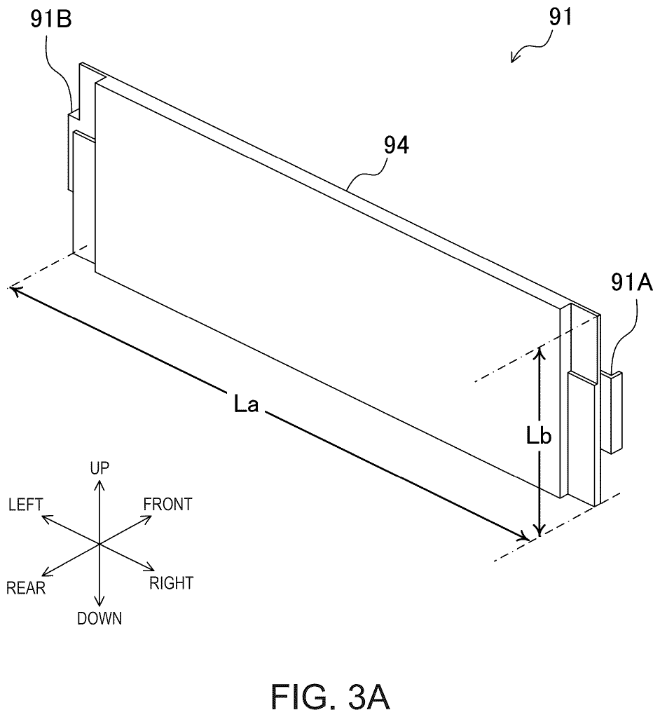

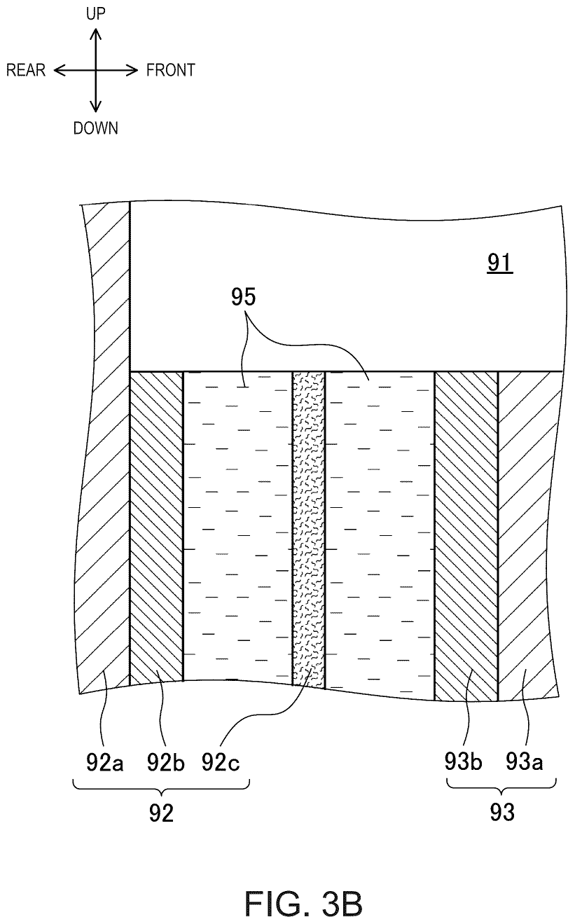

FIG. 3A is a perspective view exemplarily showing a configuration of the battery cell 91. FIG. 3B is a sectional view exemplarily showing the configuration of the battery cell 91. The section in FIG. 3B corresponds to a section taken along the front-rear direction and the vehicle height direction.

As shown in FIG. 2, each of the plurality of battery cells 91 constituting each battery module 90A-C has a plate shape. These battery cells 91 are housed in a box-like module container 90a in the state of lining up in the front-rear direction.

In detail, in each battery module 90A-C, the plurality of battery cells 91 are disposed such that their longitudinal directions extend along the vehicle width direction, their transverse directions extend along the vehicle height direction, and their thickness directions extend along the vehicle front-rear direction. Such disposition can make the dimension of each battery module 90A-C in the vehicle width direction (longitudinal direction) long while making the dimension thereof in the vehicle height direction as short as possible.

Moreover, with the module container 90a or a separate member independent of the module container 90a, on the plurality of battery cells 91 housed in each module container 90a, an external force that binds these in the front-rear direction acts.

Further, as shown in FIG. 3A, a dimension La (length) of each of the plurality of battery cells 91 in the longitudinal direction of the battery module 90A-90C is longer than a dimension Lb (width) thereof in the transverse direction of the battery module 90A-90C. In the case of the present embodiment, the dimension La in the longitudinal direction is three times or more of the dimension Lb in the transverse direction. Each battery cell 91 is a high aspect ratio battery cell. Each battery cell 91 can be referred to as what is called a blade battery or a blade cell.

Moreover, tabs 91A and 91B corresponding to a positive electrode and a negative electrode of each of the plurality of battery cells 91 are disposed at both ends of the battery cell 91 in the longitudinal direction.

More in detail, each battery cell 91 is constituted by negative electrode sheets 92 and positive electrode sheets 93 being alternately stacked. The negative electrode sheets 92 and the positive electrode sheets 93 alternately stacked are housed in a cell container 94 shown in FIG. 3A, as shown in FIG. 3B. Each battery cell 91 is a so-called lithium-ion battery using movement of lithium ions between electrodes.

As shown in FIG. 3B, the negative electrode sheet 92 has a current collector 92a, an active material 92b, and a separator 92c. The current collector 92a and the active material 92b constitute a so-called “negative electrode”. The negative electrode sheet 92 extends in the vehicle width direction to be long.

The current collector 92a is a plate material with a small thickness extending in a direction perpendicular to the stacking direction, which is in the front-rear direction of the vehicle. One of the two ends of the current collector 92a protrudes outside the cell container 94, for example, through an opening positioned on one side of the cell container 94 in the longitudinal direction. This protrusion portion constitutes the tab 91A on the negative electrode side.

The active material 92b is applied onto a surface of the current collector 92a. The active material 92b on the negative electrode side includes silicon (Si). The negative electrode including the active material 92b and the current collector 92a faces the positive electrode sheet 93, for example, via the separator 92c.

In detail, the active material 92b constituting the negative electrode active material is a mixture of a Si-based active material and a carbon-based (C-based) active material. The Si-based active material is constituted, for example, of SiO. The C-based active material is constituted, for example, of graphite.

As shown in FIG. 3B, the positive electrode sheet 93 has a current collector 93a and an active material 93b. The current collector 93a and the active material 93b constitute a so-called “positive electrode”. The positive electrode sheet 93 extends in the vehicle width direction to be long.

The current collector 93a is a plate material with a small thickness extending in a direction perpendicular to the stacking direction. One of the two ends of the current collector 93a protrudes outside the cell container 94, for example, through an opening positioned on the other side of the cell container 94 in the longitudinal direction. This protrusion portion constitutes the tab 91B on the positive electrode side.

The active material 93b is applied onto a surface of the current collector 93a. The positive electrode including the active material 93b and the current collector 93a faces the active material 92b and the current collector 92a of the negative electrode sheet 92, for example, via the separator 92c.

Moreover, an electrolytic liquid 95 is encapsulated in the cell container 94. Lithium ions pass between the electrodes via the electrolytic liquid 95. By causing current to flow into the battery cell 91 from the outside, lithium ions move to the negative electrode side. The movement of lithium ions generates a potential difference between the negative electrode and the positive electrode. The potential difference being generated by electric power supply from the outside is equivalent to the battery cell 91 being charged.

Moreover, the potential difference mentioned above is relieved by lithium ions moving from the negative electrode side to the positive electrode side. At that time, current is to flow from the battery cell 91 to the outside. The potential difference being relieved by electric power supply to the outside is equivalent to the battery cell 91 discharging.

### 2. Configuration of Control Apparatus

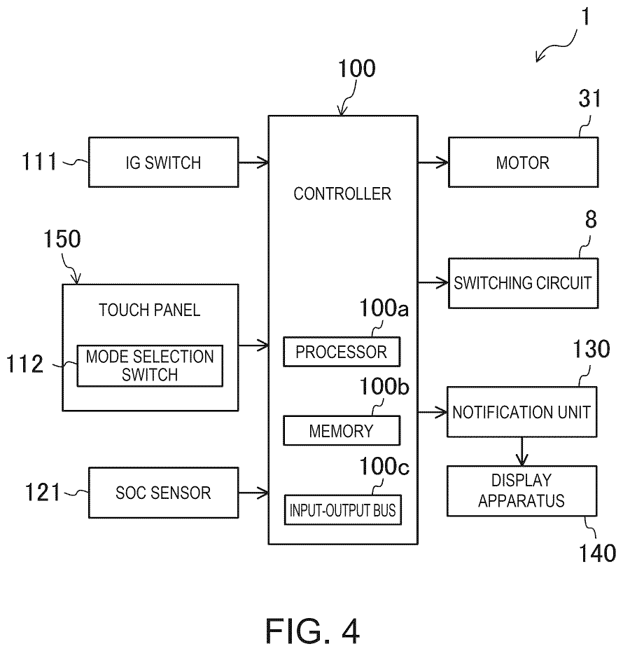

FIG. 4 is a block diagram exemplarily showing a configuration of the control apparatus 1 for the secondary battery 9. The control apparatus 1 includes switches such as an IG switch 111 and a mode selection switch 112, sensors such as SOC sensors 121, a notification unit 130, a controller 100, and the switching circuit 8 mentioned above.

The IG switch 111 is a switch for supplying electricity to the motor 31 of driving source 3 of the vehicle V. The IG switch 111 is electrically connected to the controller 100. When the IG switch 111 is manipulated, an electric signal for switching an operation mode of the vehicle V between “IG-ON” and “IG-OFF” is input into the controller 100. The IG switch 111 can also be called a power switch or an ignition switch.

The mode selection switch 112 is a switch for switching a discharge mode of the secondary battery 9. The mode selection switch 112 is electrically connected to the controller 100. When the mode selection switch 112 is manipulated, an electric signal corresponding to the content of the manipulation is input into the controller 100. Details of the discharge mode are mentioned later.

Notably, the mode selection switch 112 may be configured on a screen of a touch panel-type liquid crystal panel or organic EL panel, or may be configured as physical switches such as push buttons and toggle switches. In the case of the present embodiment, the mode selection switch 112 is displayed on a touch panel 150 arranged at a different position from that of a display apparatus 140.

The “IG-OFF” is a mode used in a non-traveling state of the vehicle V such as while in park or while the occupant leaves the vehicle V (particularly during power source disconnection of the driving source 3). In this mode, charge and discharge of the secondary battery 9 are restricted. In other words, in this mode, the secondary battery 9 and the driving source 3 are electrically separated (the electric connection therebetween is disconnected). As a result, both electric power supply from the secondary battery 9 to the driving source 3 and electric power supply from the driving source 3 to the secondary battery 9 are to be disconnected.

The “IG-ON” is a mode mainly used in a traveling state of the vehicle V (particularly while power is turned on for the driving source 3). In this mode, charge and discharge of the secondary battery 9 are allowed. In other words, in this mode, electricity is turned on for the secondary battery 9 and the driving source 3 (they are electrically connected). As a result, both electric power supply from the secondary battery 9 to the driving source 3 and electric power supply from the driving source 3 to the secondary battery 9 are allowed.

The SOC sensors 121 detect SOCs of the plurality of battery modules 90A-C. Omitted from FIG. 4, the SOC sensors 121 are individually attached to the plurality of battery modules 90A-C. In other words, the SOC sensors 121 individually detect the SOCs of the respective battery modules 90A-C. The SOC sensors 121 are an exemplary illustration of an SOC sensor according to the present embodiment.

In detail, each SOC sensor 121 outputs a signal corresponding to the SOC for the corresponding battery module 90A-C. More in detail, the SOC sensor 121 outputs the signal corresponding to the SOC, based on a measurement value of an open circuit voltage (OCV). The SOC sensor 121 can be constituted of a voltage sensor that can measure a circuit voltage. The SOC sensor 121 is electrically connected to the controller 100. The SOC sensor 121 inputs the detection signal into the controller 100.

The notification unit 130 is electrically connected to the controller 100. The notification unit 130 is configured to notify an occupant of the vehicle V of information related to processing by the controller 100 mentioned later.

In detail, the notification unit 130 according to the present embodiment is electrically connected to the display apparatus 140 positioned in front of a driver's seat of the vehicle V. The display apparatus 140 has a screen displaying indicators such as a tachometer, a remaining battery amount, and the like. By controlling the contents of display on the screen of the display apparatus 140, the notification unit 130 notifies the occupant of the aforementioned information.

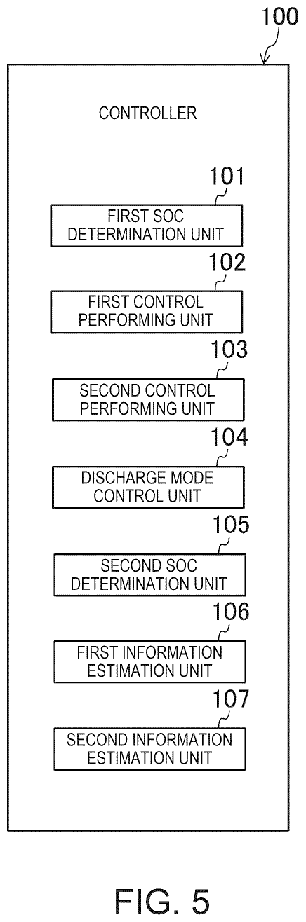

The controller 100 includes hardware such as a processor 100a, a memory 100b, and an input-output bus 100c and software such as a database and a control program. For functional elements related to the latter software, refer to FIG. 5. That is, each of the units 101-107 in controller 100 may be software stored in the memory 100b and executable by the processor 100a to achieve its respective function.

Notably while one controller 100 is shown for the control apparatus 1 in FIG. 4, this controller 100 may be constituted, for example, by a module (PCM) for controlling the driving source 3, among various control modules mounted on the vehicle V.

Based on signals input from the switches and the sensors mentioned above, the controller 100 performs processing related to charge and discharge of the secondary battery 9. In order to perform such processing, the controller 100 includes a plurality of functional blocks shown in FIG. 5.

### 3. Details of Controller

The controller 100 according to the embodiment is configured to switch the electric connections between the plurality of battery modules 90A-C and the driving source 3 based on the detection signals of the SOC sensors 121.

Specifically, as shown in FIG. 5, the controller 100 includes a first SOC determination unit 101, a first control performing unit 102, a second control performing unit 103, a discharge mode control unit 104, a second SOC determination unit 105, a first information estimation unit 106, and a second information estimation unit 107.

### (3-1. First SOC Determination Unit)

Based on the detection signals of the SOC sensors 121, the first SOC determination unit 101 determines whether or not, for at least one of the plurality of battery modules 90A-C, the SOC is not less than a predetermined first reference value. That this determination is NO is equivalent to the case where, for all of the plurality of battery modules 90A-C, the SOCs are less than the predetermined first reference value.

Namely, the first SOC determination unit 101 can be regarded as determining whether or not the SOCs are less than the first reference value based on the detection signals of the SOC sensors 121 for all of the plurality of battery modules 90A-C.

The first reference value is a reference value corresponding to an SOC less than full charge. In the present embodiment, the first reference value is set to any value within a range, in detail, not less than 10% and not more than 30%, more in detail, not less than 15% and not more than 25% relative to the fully charged state (100%). In the following description, there is a case where the “first reference value=20%” is regarded as a tentative setting.

For each of the plurality of battery modules 90A-C, the first SOC determination unit 101 determines whether or not the SOC of the battery module 90A-C is not less than the first reference value. Electric signals indicating the determination results by the first SOC determination unit 101 are input into the first control performing unit 102, the second control performing unit 103, and the discharge mode control unit 104.

### (3-2. First Control Performing Unit)

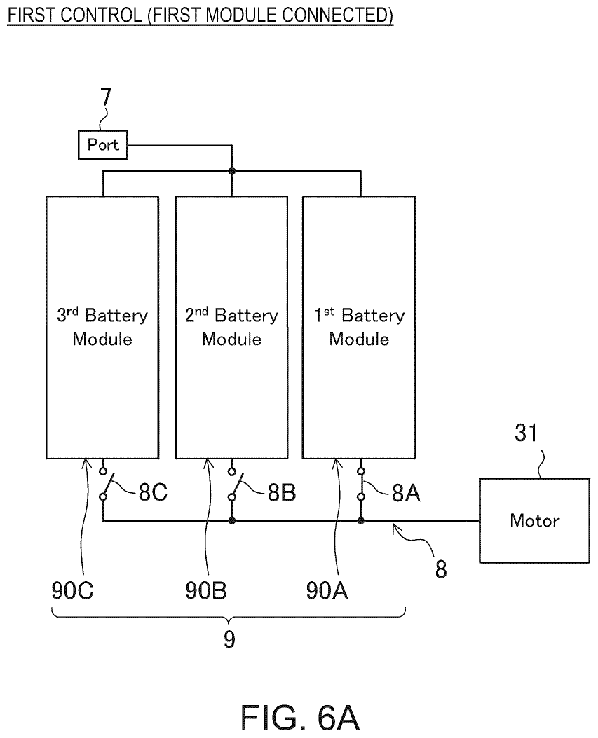

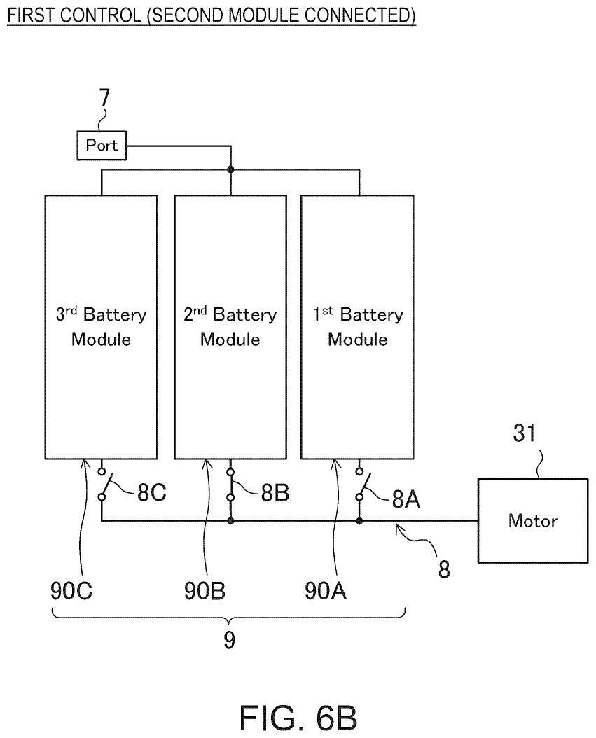

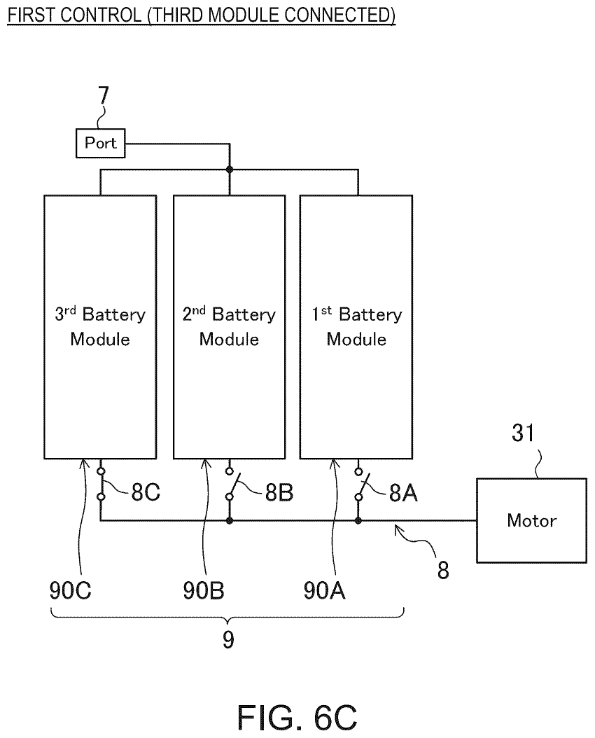

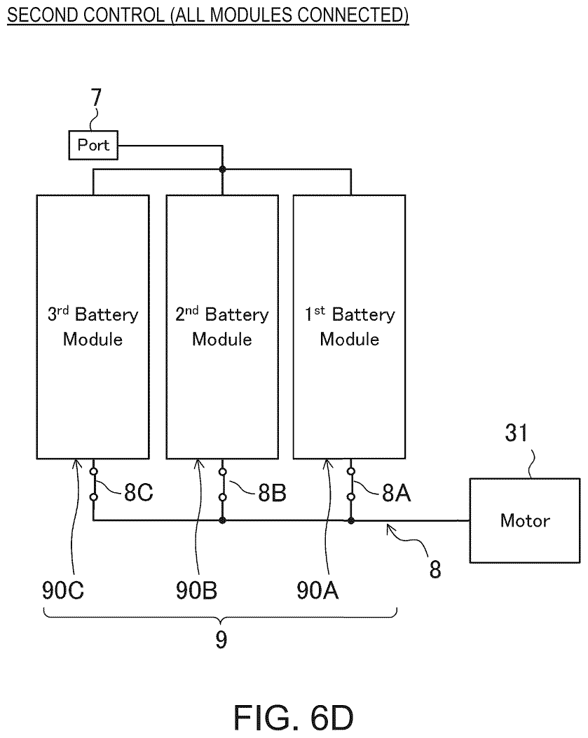

FIG. 6A, FIG. 6B, and FIG. 6C are diagrams for explaining a first control. When the SOC of at least one battery module 90A-C is not less than the first reference value, the first control performing unit 102 performs a predetermined first control. In detail, the first control performing unit 102 performs the first control for the battery module(s) 90 the SOC(s) of which are not less than the first reference value out of the plurality of battery modules 90A-C. The first control performing unit 102 receives control signals from the first SOC determination unit 101 and the discharge mode control unit 102 to perform the first control.

Herein, the first control is processing of connecting the plurality of battery modules 90A-C one by one to the motor 31 and causing the plurality of battery modules 90A-C to discharge one by one until the SOC of each battery module 90A-C has decreased to the first reference value. The first control performing unit 102 causes the battery modules 90A-C to be connected one by one to the motor 31 to supply electric power to the motor 31. The first control can be performed by the first control performing unit 102 being controlling the switching circuit 8 based on the detection signals of the SOC sensors 121.

For example, it is supposed that the SOCs of all of the battery modules 90A-C are not less than the first reference value. In this case, the controller 100 first brings only the first module 90A into the connected state, and brings the second module 90B and the third module 90C into the disconnected states (refer to FIG. 6A). Thereby, on the traveling of the vehicle V, only the first module 90A is to discharge.

After that, it is supposed that the SOC of the first module 90A has decreased to the first reference value. In this case, the controller 100 brings, subsequently to the first module 90A, the second module 90B into the connected state, and brings the third module 90C and the first module 90A into the disconnected states (refer to FIG. 6B). Thereby, on the traveling of the vehicle V, only the second module 90B is to discharge.

After that, it is supposed that the SOC of the second module 90B has decreased to the first reference value. In this case, the controller 100 brings, subsequently to the second module 90B, the third module 90C into the connected state, and brings the first module 90A and the second module 90B into the disconnected states (refer to FIG. 6C). Thereby, during the traveling of the vehicle V, only the third module 90C is to discharge.

### (3-3. Second Control Performing Unit)

FIG. 6D is a diagram for explaining a second control. When the SOCs of all of the battery modules 90A-C are less than the first reference value, the second control performing unit 103 performs a predetermined second control. In detail, for all of the plurality of battery modules 90A-C, the second control performing unit 103 performs the second control. The second control performing unit 103 receives control signals from the first SOC determination unit 101 and the discharge mode control unit 104 to perform the second control.

Herein, the second control is processing of connecting the plurality of battery modules 90A-C to the motor 31 in parallel and simultaneously causing the plurality of battery modules 90A-C to discharge (refer to FIG. 6D). The second control performing unit 103 simultaneously causes the plurality of battery modules 90A-C connected to the motor 31 to supply electric power to the motor 31. The second control can be performed by the second control performing unit 103 controlling the switching circuit 8 based on the detection signals of the SOC sensors 121.

The second control is set, when the SOCs of all of the battery modules 90A-C decrease to the first reference value by the first control, to be started in accordance with selection of the discharge mode.

### (3-4. Discharge Mode Control Unit)

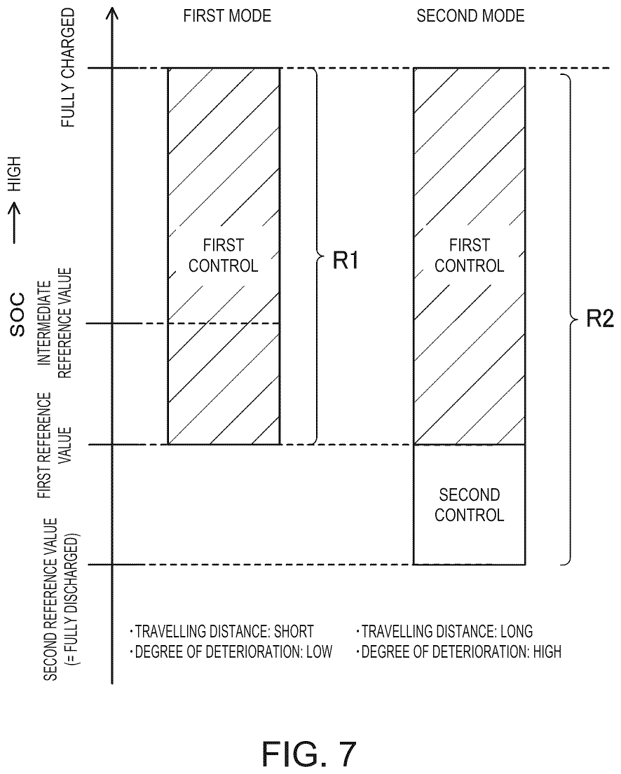

FIG. 7 is a diagram for explaining a plurality of discharge modes. The discharge mode control unit 104 selects one discharge mode from among a plurality of discharge modes, based on a setting input by an occupant. In the present embodiment, the setting input by an occupant is an operation input with respect to the mode selection switch 112. The discharge mode control unit 102 selects the one discharge mode that is selected via the mode selection switch 112 by the occupant, from among the plurality of discharge modes.

For example, the selection of the discharge mode may be performed before the traveling of the vehicle V after the vehicle V is started by being brought into IG-ON, or as mentioned later, may be performed during the traveling of the vehicle V based on the detection signals of the SOC sensors 121.

After that, the discharge mode control unit 104 selects and performs one of the first control and the second control based on the detection signals of the SOC sensors 121 so as to attain the selected one discharge mode. The first control and the second control are performed via the first control performing unit 102 and the second control performing unit 103 mentioned above.

Herein, the plurality of discharge modes includes the first mode and the second mode. The first mode and the second mode are different in SOC range used for the secondary battery 9. As shown in FIG. 7, an SOC range RI used in the first mode and an SOC range R2 used in the second mode are different in a lower limit value of the SOC range.

The first mode is a discharge mode that allows discharge from the fully charged state (SOC=100%) to the first reference value (SOC=20%). When the first mode is selected, under the condition that the SOC has decreased to the first reference value, the electric power supply from the secondary battery 9 to the motor 31, and then, the traveling of the vehicle V are stopped.

Therefore, in the first mode, the SOC of the secondary battery 9 is not consumed until it is less than the first reference value. In the first mode, only the first control is to be performed. Namely, the first mode is a discharge mode of continuing the first control regardless of the detection signals of the SOC sensors 121 by allowing discharge within the SOC range RI with the first reference value as a lower limit. The first mode is a more suitable discharge mode for restraining deterioration of the secondary battery 9 than the second mode, and this can also be called a “deterioration restraining mode”.

The second mode is a discharge mode that allows discharge from the fully charged state (SOC=100%) to a second reference value. The second reference value is a reference value corresponding to an SOC less than the first reference value.

Specifically, the second reference value according to the present embodiment is set to the SOC (=0%) corresponding to the fully discharged state. When the second mode is selected, even when the SOC has decreased to the first reference value, the traveling of the vehicle V can be continued until the SOC reaches the second reference value (SOC-0%).

Therefore, in the second mode, the SOC of the secondary battery 9 is consumed until it is less than the first reference value. In the second mode, the first control and the second control are configured to switch at the first reference value as the boundary. Namely, the second mode is a discharge mode of properly using the first control and the second control in accordance with the detection signals of the SOC sensors 121 by allowing discharge within the SOC range R2 with the second reference value as the lower limit. The second mode is a more suitable discharge mode for long distance traveling of the vehicle V than the first mode, and this can also be called a “long distance traveling mode”.

### (3-5. Second SOC Determination Unit)

Based on the detection signals of the SOC sensors 121, the second SOC determination unit 105 determines whether or not the SOC of the entirety of the plurality of battery modules 90A-C has decreased to a predetermined intermediate reference value.

The intermediate reference value is a predetermined value corresponding to an SOC that is set to be higher than the first reference value and lower than the fully charged state. In the present embodiment, the intermediate reference value is set to a value higher than the first reference value and not more than 40%, more in detail, higher than the first reference value and not more than 35%. In the following description, there is a case where the “intermediate reference value=30%” is regarded as a tentative setting.

For example, the second SOC determination unit 105 calculates an average value of the SOCs individually detected for the plurality of battery modules 90A-C, and compares the average value and the intermediate reference value. When the average value has decreased to the intermediate reference value, the second SOC determination unit 105 determines that the SOC of the entirety of the plurality of battery modules 90A-C has decreased to the predetermined intermediate reference value. An electric signal indicating the determination result by the second SOC determination unit 105 is input into the second information estimation unit 107.

### (3-6. First Information Estimation Unit)

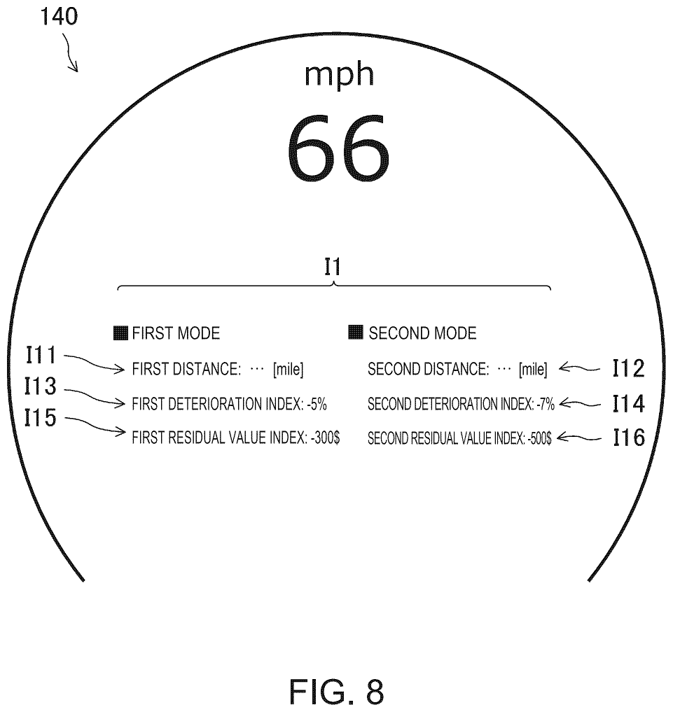

FIG. 8 is a diagram for explaining first information 11. Based on various kinds of information regarding the vehicle V, the first information estimation unit 106 estimates the first information 11. The first information estimation unit 106 notifies the occupant of the estimated first information Il by controlling the display apparatus 140 via the notification unit 130.

The estimation and the notification of the first information Il are performed, for example, at the timing after the driving source 3 is started (for example, after IG-ON of the vehicle V) and before the vehicle V starts to travel. The first information Il includes indices as guides for selection at the time of selection of the first mode and the second mode by the occupant.

Herein, as shown in FIG. 8, the first information Il is at least configured to include a first distance 111, a second distance 112, a first deterioration index 113, and a second deterioration index 114.

The first distance I11 indicates a travelable distance of the vehicle V in the first mode. The second distance 112 indicates a travelable distance of the vehicle V in the second mode. Since in the second mode, a wider SOC range is used than in the first mode (in other words, a discharge depth of the second mode is deeper than a discharge depth of the first mode), the second distance 112 is longer than the first distance 111.

The first distance I11 can be estimated based on a current SOC of the whole secondary battery 9, an electric power amount that can be used in the first mode, a torque load of the motor 31, and a rotational speed of the motor 31.

The second distance 112 can be estimated based on the current SOC of the whole secondary battery 9, an electric power amount that can be used in the second mode, the torque load of the motor 31, and the rotational speed of the motor 31.

The first deterioration index 113 indicates the degree of deterioration of the maximum capacity of the secondary battery 9 after traveling of the whole first distance 111. The first deterioration index 113 is an index indicating a decrease amount of the maximum capacity of the secondary battery 9 (maximum value of the battery capacity) at the timing when the whole first distance I11 has been traveled. In the case of the present embodiment, the larger the decrease amount of the maximum capacity is, the larger the first deterioration index 113 is.

For example, the maximum capacity (initial capacity) of the secondary battery 9 as new is regarded as 100%, and the maximum capacity of the secondary battery 9 in the state where the rechargeable electric power amount is zero is regarded as 0%.

Further, it is supposed that the current maximum capacity (current capacity) of the secondary battery 9 is tentatively 90% and this maximum capacity is estimated to decrease to tentatively 87% after the traveling of the whole first distance 111. In this case, as the first deterioration index 113, a decrease amount from the current capacity “3% (-90%-87%)” can be used, for example.

The first deterioration index 113 can be estimated based on the current capacity, the current SOC of the whole secondary battery 9, a temperature of the secondary battery 9, the electric power amount that can be used in the first mode, and the like. Every time the secondary battery 9 is charged, the current capacity is configured to be updated each time based on the number of cycles of charge and discharge, and the like and to be recorded each time.

The second deterioration index 114 indicates the degree of deterioration of the maximum capacity of the secondary battery 9 after traveling of the whole second distance 112. The second deterioration index 114 is an index indicating a decrease amount of the maximum capacity of the secondary battery 9 (maximum value of the battery capacity) at the timing when the whole second distance 112 has been traveled. In the case of the present embodiment, the larger the decrease amount of the maximum capacity is, the larger the second deterioration index 114 is.

For example, the maximum capacity (initial capacity) of the secondary battery 9 as new is regarded as 100%, and the maximum capacity of the secondary battery 9 in the state where the rechargeable electric power amount is zero is regarded as 0%.

Further, it is supposed that the current maximum capacity (current capacity) of the secondary battery 9 is tentatively 90% and this maximum capacity is estimated to decrease to tentatively 85% after traveling of the whole second distance 112. In this case, as the second deterioration index 114, a decrease amount from the current capacity “5% (=90%-85%)” can be used, for example.

The second deterioration index 114 can be estimated based on the current capacity, the current SOC of the whole secondary battery 9, the temperature of the secondary battery 9, the electric power amount that can be used in the second mode, and the like. The current capacity is configured to be recorded every time when the secondary battery 9 is charged.

In the second mode, a wider SOC range is used than in the first mode (in other words, the discharge depth of the second mode is deeper than the discharge depth of the first mode). Moreover, the current capacity takes the same value both in selection of the first mode and in selection of the second mode. Accordingly, the second mode is larger in degree of deterioration of the secondary battery 9 than the first mode. The second deterioration index 114 is larger than the first deterioration index 113.

As shown in FIG. 8, by displaying the first distance 111 and the first deterioration index 113 which are related to the first mode and the second distance 112 and the second deterioration index 114 which are related to the second mode side by side, the occupant can be allowed to compare driving the vehicle V in the first mode suitable for restraining deterioration of the secondary battery 9 and driving the vehicle V in the second mode suitable for long distance traveling.

Furthermore, as shown in FIG. 8, the first information Il is configured to include both of a first residual value index 115 and a second residual value index 116. When estimating the first information 11, the first information estimation unit 106 individually estimates the first residual value index 115 and the second residual value index 116. The first information estimation unit 106 notifies the occupant of the first information Il including the first residual value index 115 and the second residual value index 116 by controlling the display apparatus 140 via the notification unit 130.

The first residual value index 115 indicates an economic value of the secondary battery 9 after traveling of the whole first distance 111. The “economic value” stated here may be a retail price of the secondary battery 9 or may be a replacement cost thereof. The first residual value index 115 may be the economic value of the secondary battery 9 or may be a change amount of this economic value, at the timing when the whole first distance I11 has been traveled.

For example, it is assumed that the economic value of the secondary battery 9 as new is ten thousand dollars. Further, as in the aforementioned example, it is supposed that the current capacity is estimated to decrease from “90%” to “87%” at the time point when the whole first distance I11 has been traveled. The first deterioration index 113 in this case can be estimated to be “3%”, for example.

In this case, the first residual value index 115 as the changed amount of the economic value can be estimated to be “300 dollars” obtained by multiplying “ten thousand dollars” mentioned above by the first deterioration index 113. This estimation result can be interpreted as “When the whole first distance I11 has been traveled in the first mode, the economic value of the secondary battery 9 will have decreased by 300 dollars”.

The second residual value index 116 indicates an economic value of the secondary battery 9 after traveling of the whole second distance 112. The “economic value” stated here may be a retail price of the secondary battery 9 or may be a replacement cost thereof. The second residual value index 116 may be the economic value of the secondary battery 9 or may be a changed amount of this economic value, at the timing when the whole second distance 112 has been traveled.

For example, it is assumed that the economic value of the secondary battery 9 as new is ten thousand dollars. Further, as in the aforementioned example, it is supposed that the current capacity is estimated to decrease from “90%” to “85%” at the time point when the whole second distance 112 has been traveled. The second deterioration index 114 in this case can be estimated to be “5%”, for example.

In this case, the second residual value index 116 as the changed amount of the economic value can be estimated to be “500 dollars” obtained by multiplying “ten thousand dollars” mentioned above by the second deterioration index 114. This estimation result can be interpreted as “When the whole second distance 112 has been traveled in the second mode, the economic value of the secondary battery 9 will have decreased by 500 dollars”.

As shown in FIG. 8, by displaying the first distance I11 and the first residual value index 115 which are related to the first mode and the second distance 112 and the second residual value index 116 which are related to the second mode side by side, the occupant can be allowed to compare, from an economic viewpoint, driving the vehicle V in the first mode suitable for restraining deterioration of the secondary battery 9 and driving the vehicle V in the second mode suitable for long distance traveling.

In other words, while the first deterioration index 113 and the second deterioration index 114 are difficult for a general user to understand intuitively, by displaying them along with the first residual value index 115 and the second residual value index 116, the occupant can be prompted to weigh the long and short traveling distances and the high and low economic losses.

### (3-7. Second Information Estimation Unit)

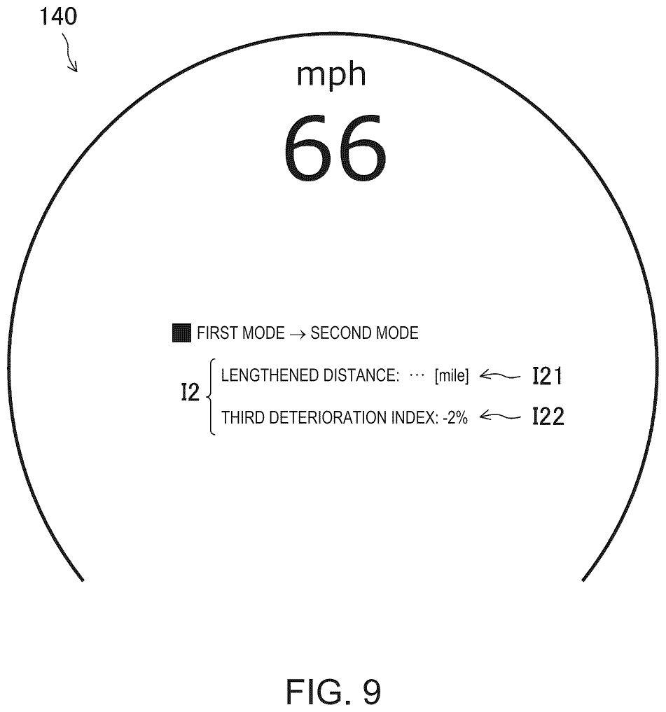

FIG. 9 is a diagram for explaining second information 12. Based on various kinds of information regarding the vehicle V, the second information estimation unit 107 estimates the second information 12. The second information estimation unit 107 notifies the occupant of the estimated second information 12 by controlling the display apparatus 140 via the notification unit 130.

The estimation and the notification of the second information 12 are performed, for example, after the driving source 3 is started (for example, after IG-ON of the vehicle V) and during the traveling of the vehicle V under selection of the first mode. For example, the timing of the notification of the second information 12 may be a timing when the SOC of the entirety of the plurality of battery modules 90A-C has decreased to the intermediate reference value with the second SOC determination unit 105. The second information 12 includes the indices as guides for selection of whether or not switching from the first mode to the second mode is performed during the traveling of the vehicle V.

Herein, as shown in FIG. 9, the second information 12 is at least configured to include a lengthened distance 121 and a third deterioration index 122.

The lengthened distance 121 indicates a lengthened amount of the travelable distance in the case where switching from the first mode to the second mode is performed. For example, the lengthened distance 121 may be a value obtained by subtracting the first distance I11 from the second distance 112, or may be estimated based on the torque load and the rotational speed of the motor 31, and the like, at that time point.

The third deterioration index 122 indicates the degree of deterioration of the maximum capacity of the secondary battery 9 after traveling of the whole lengthened distance 121. The third deterioration index 122 is an index indicating a decrease amount of the maximum capacity (maximum value of the battery capacity) of the secondary battery 9 at the timing when the whole lengthened distance 121 has been traveled. For example, the third deterioration index 122 may be a value obtained by subtracting the first deterioration index 113 from the second deterioration index 114, or may be estimated based on the temperature of the secondary battery 9, and the like, at that time point.

As shown in FIG. 9, by displaying the lengthened distance 121 and the third deterioration index 122 in a row, the occupant can be allowed to compare continuing to drive the vehicle V while keeping the first mode and continuing to drive the vehicle V after switching from the first mode to the second mode.

### 4. Specific Example of Processing by Controller

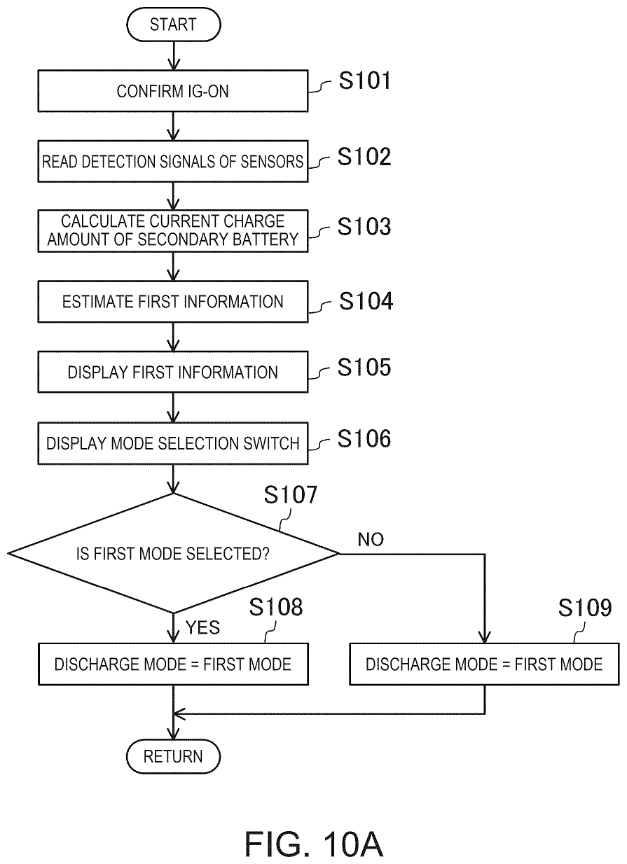

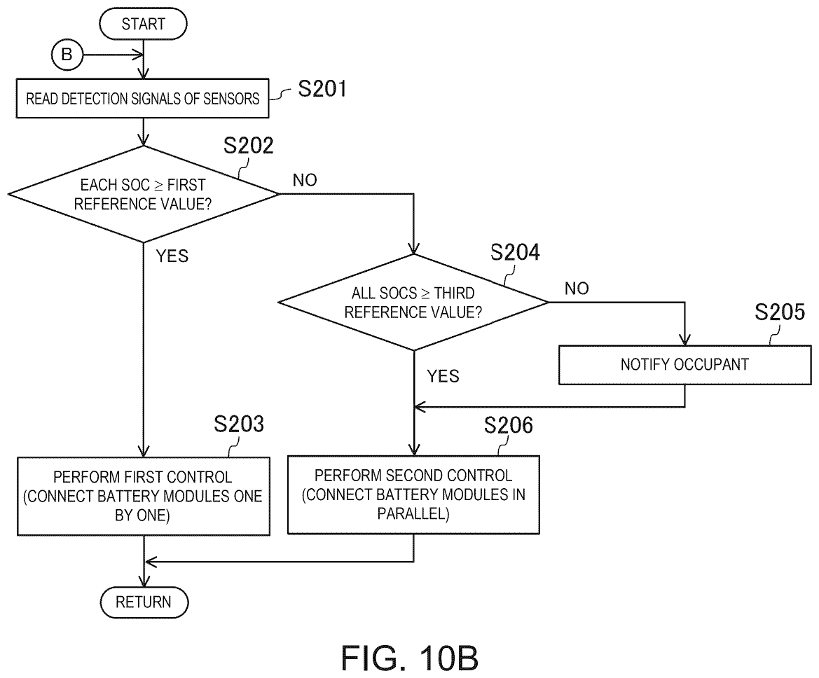

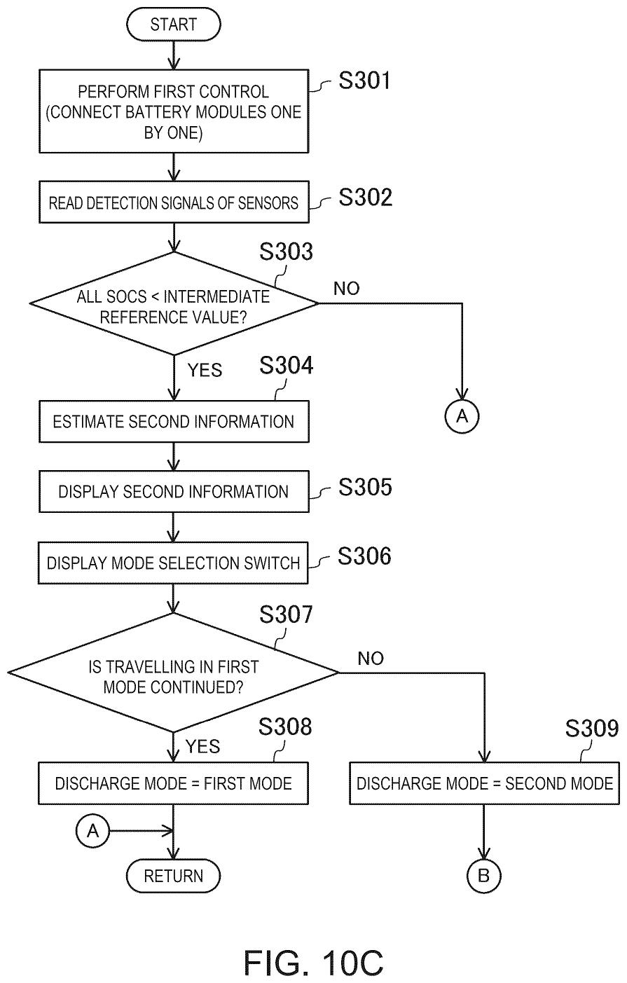

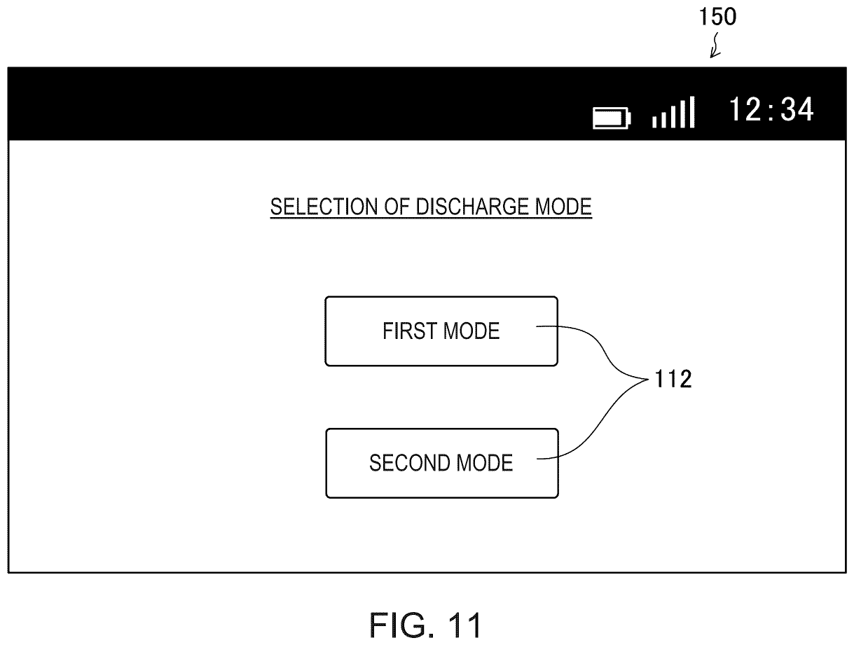

FIG. 10A is a flowchart showing a specific example of processing regarding selection of the first mode and the second mode. Moreover, FIG. 11 is a diagram exemplarily showing the mode selection switch 112 on the touch panel 150.

First, in step S101, the controller 100 confirms being in the “IG-ON” state. This confirmation can be performed based on whether or not the electric signal related to the IG switch 111 has been input into the controller 100. In the case of not being in the “IG-ON” state, the controller 100 ends the processing in FIG. 10A.

Subsequently in step S102, the controller 100 reads detection signals of sensors. The sensors as targets of the signal reading include the SOC sensors 121 and temperature sensors 122.

Subsequently in step S103, based on the detection signals of the SOC sensors 121, the controller 100 calculates a current charge amount of the secondary battery 9. This calculation can be performed based on the detection signals of the SOC sensors 121, the initial capacity mentioned above, and a current maximum capacity. The current maximum capacity is configured to be recorded every time when the secondary battery 9 is charged as mentioned later.

Subsequently in step S104, the first information estimation unit 106 estimates the first information 11. The estimated first information Il includes information related to the first mode and information related to the second mode. The former information related to the first mode is configured to include the first distance 111, the first deterioration index 113, and the first residual value index 115. Meanwhile, the latter information related to the second mode is configured to include the second distance 112, the second deterioration index 114, and the second residual value index 116.

Subsequently in step S105, the first information estimation unit 106 displays the first information I1 estimated in step S104 on the screen of the display apparatus 140 by controlling the display apparatus 140 via the notification unit 130.

Subsequently in step S106, by controlling the display screen on the touch panel 150, the discharge mode control unit 104 displays the mode selection switch 112 on the screen (refer to FIG. 11). The discharge mode control unit 104 accepts selection of the discharge mode by the occupant based on the setting input with respect to the mode selection switch 112.

Subsequently in step S107, the controller 100 determines whether or not the first mode is selected in step S106. When this determination is YES, the controller 100 puts the control process forward to step S108. When it is put forward to step $108, the discharge mode control unit 104 sets the discharge mode to the first mode. Details of processing to be performed afterward is mentioned later.

On the other hand, when the determination in step S107 is NO, the controller 100 puts the control process forward to step S109. When it is put forward to step S109, the discharge mode control unit 104 sets the discharge mode to the second mode.

### (4-1. Processing Related to Second Mode)

FIG. 10B is a flowchart exemplarily showing processing related to the second mode. The flow shown in FIG. 10B exemplarily shows a series of processes performed when the control process is put forward to step S109 in FIG. 10A. The flow in FIG. 10B is configured to be repeatedly performed while traveling in the second mode.

First, in step S201 in FIG. 10B, the first SOC determination unit 101 reads the detection signals of the SOC sensors 121 as in step S102 in FIG. 10A. The first SOC determination unit 101 performs a determination based on the read detection signals.

Subsequently in step S202, based on the determination result by the first SOC determination unit 101, the discharge mode control unit 104 determines whether or not, for at least one of the plurality of battery modules 90A-C, the SOC is not less than the predetermined first reference value.

When the determination in step S202 is YES, the discharge mode control unit 104 puts the control process forward to step S203, and when this determination is NO, puts the control process forward to step S204.

In step S203, the discharge mode control unit 104 performs the first control via the first control performing unit 102. The first control performing unit 102 selects, from among the plurality of battery modules 90A-C, a battery module 90A-C having the SOC not less than the first reference value, and connects the battery module 90A-C to the motor 31. When the process in step S203 is completed, the controller 100 ends the processing in FIG. 10B. When the IG-ON state is kept, the controller 100 repeats the series of processes sequentially from step S201 in FIG. 10B.

In step S204, based on the determination result by the first SOC determination unit 101, the discharge mode control unit 104 determines whether or not, for all of the plurality of battery modules 90A-C, the SOCs are not less than a third reference value. The third reference value is a reference value that is higher than the value corresponding to the SOC in the fully discharged state and less than the first reference value. The third reference value may be set to a value corresponding to an SOC, in detail, not more than “SOC=10%”, more in detail, not more than “SOC=5%”.

When the determination in step S204 is YES, the discharge mode control unit 104 skips step S205 and puts the control process forward to step S206. When the determination in step S204 is NO, the discharge mode control unit 104 puts the control process forward to step S205.

In step S205, the controller 100 notifies the occupant to stop the vehicle and to perform charging, through the display apparatus 140 and/or the like. When this notification is completed, the controller 100 puts the control process forward to step S206.

In step S206, the discharge mode control unit 104 performs the second control via the second control performing unit 103. The second control performing unit 103 connects the plurality of battery modules 90A-C to the motor 31 in parallel. When the process in step S206 is completed, the controller 100 ends the processing in FIG. 10B. After that, while the IG-ON state is being kept, the controller 100 repeats the series of processes sequentially from step S201 in FIG. 10B.

### (4-2. Processing Related to First Mode)

FIG. 10C is a flowchart exemplarily showing processing related to the first mode. The flow shown in FIG. 10C exemplarily shows a series of processes performed when the control process is put forward to step S108 in FIG. 10A. The flow shown in FIG. 10C is configured to be repeatedly performed while traveling in the first mode.

First, in step S301 in FIG. 10C, the discharge mode control unit 104 performs the first control via the first control performing unit 102. The first control performing unit 102 selects, from among the plurality of battery modules 90A-C, a battery module 90A-C having the SOCs not less than the first reference value, and connects the battery module 90A-C to the motor 31. When the process in step S301 is completed, the controller 100 puts the control process forward to step S302.

Subsequently in step S302, the second SOC determination unit 105 reads the detection signals of the SOC sensors 121 as in step S102 in FIG. 10A. The second SOC determination unit 105 performs a determination based on the read detection signals.

Subsequently in step S303, based on the determination result by the second SOC determination unit 105, the controller 100 determines whether or not the SOC of the entirety of the plurality of battery modules 90A-C has decreased to the predetermined intermediate reference value.

When the determination in step S303 is YES, the controller 100 puts the control process forward to step S304, and when this determination is NO, ends the processing shown in FIG. 10C. After that, while the IG-ON state is being kept, the controller 100 repeatedly performs the series of processes sequentially from step S301 in FIG. 10C.

Subsequently in step S304, the second information estimation unit 107 estimates the second information 12. The estimated second information 12 is configured to include the lengthened distance 121 and the third deterioration index 122.

Subsequently in step S305, the second information estimation unit 107 displays the second information 12 estimated in step S304 on the screen of the display apparatus 140 by controlling the display apparatus 140 via the notification unit 130.

Subsequently in step S306, by controlling the display screen on the touch panel 150, the discharge mode control unit 104 displays the mode selection switch 112 on the screen (refer to FIG. 11). Based on the setting input with respect to the mode selection switch 112, the discharge mode control unit 104 accepts selection of the discharge mode by the occupant, in other words, an instruction to switch from the first mode to the second mode.

Subsequently in step S307, the controller 100 determines whether or not continuing to travel in the first mode is selected in step S306. When this determination is YES, the controller 100 puts the control process forward to step S308. When it is put forward to step S308, the discharge mode control unit 104 keeps the discharge mode to be in the first mode, and ends the flow shown in FIG. 10C. After that, while the IG-ON state is being kept, the controller 100 is to perform the series of processes shown in FIG. 10C repeatedly sequentially from step S301 in the figure.

On the other hand, when the determination in step S307 is NO (when the instruction to switch from the first mode to the second mode is accepted), the controller 100 puts the control process forward to step S309. When it is put forward to step S309, the discharge mode control unit 104 changes the discharge mode to the second mode. After that, the controller 100 moves the control process from step S09 in FIG. 10C to step S201 in FIG. 10B. In this case, the series of processes subsequently to step S201 in the figure is to be started.

### 5. Significance of Individual Controls

As described above, according to the embodiment, the controller 100 performs the first control when the SOC is not less than the first reference value (refer to FIG. 7 and FIG. 10B). Performing the first control can keep the number of battery cells 91 as targets of charge and discharge as few as possible, as compared with the case where the plurality of battery modules 90A-C are connected in parallel. This can restrain the frequency of expansion and contraction occurring in the battery cells 91 caused by the intercalation reaction and/or the like, and restrain the performance deterioration of the secondary battery 9 caused by peeling-off of the negative electrode active material 92b.

Moreover, in the case where the discharge depths of the battery cells 91 are deep, such as the case where the SOC is less than the first reference value, there arises concern of performance deterioration from other than that of the peeling-off, caused by the C-rate taking a high rate. Therefore, as clearly shown in FIG. 7, under conditions where such concern is supposed, the controller 100 does not perform the first control. This is significantly advantageous to restraining the performance deterioration of the secondary battery 9.

Moreover, as exemplarily shown in FIG. 7 and FIG. 10B, when the discharge depths of the battery cells 91 become deep, the plurality of battery modules 90A-C are connected to the motor 31 in parallel. This can restrain the C-rate per battery module 90A-C, consequently, per battery cell 91, and is advantageous to restraining the performance deterioration of the secondary battery 9. By switching the electric connections in accordance with the SOCs, the performance deterioration of the secondary battery 9 can be restrained as much as possible.

Moreover, as described with reference to FIG. 7 and the like, since the first reference value is the lower limit, the first mode results in a shorter travelable distance than the second mode, but is also more effective in restraining the performance deterioration of the secondary battery 9 than the second mode. The first mode and the second mode are unable to lengthen both the travelable distance and the service life of the secondary battery 9 but are rather configured to give priority to one of these effects. The occupant can drive the vehicle V in the first mode or drive the vehicle V in the second mode.

As above, by employing a configuration of leading the occupant to select one of the first mode and the second mode without being fixed to the first mode or the second, flexible discharge control can be attained in accordance with the preference of the occupant, the situation of the occupant, and the like. This can improve usability of the vehicle V and the cells 91.

Moreover, by notifying the occupant of the first information Il as exemplarily shown in FIG. 8, an advantage of the first mode and an advantage of the second mode can be quantitatively grasped. Thereby, flexible discharge control can be attained in accordance with the preference of the occupant, the situation of the occupant, and the like. This can improve usability of the vehicle V.

Moreover, while the second mode which leads to a longer travelable distance tends to be selected when only the first distance Ill and the second distance 112 are displayed, by simultaneously making notification of the first deterioration index 113 and the second deterioration index 114 along with the above, the occupant can be led to grasp the degree of deterioration of the secondary battery 9 quantitatively. This can increase the frequency of selection of the first mode, and is advantageous to restraining the performance deterioration of the secondary battery 9.

Moreover, as exemplarily shown in FIG. 8, by further making notification of the first residual value index 115 and the second residual value index 117, the occupant can be led to grasp the degree of deterioration of the secondary battery 9 more appropriately. This can increase the frequency of selection of the first mode, and is advantageous to restraining the performance deterioration of the secondary battery 9.

Moreover, as described using FIG. 10C, the controller 100 accepts change from the first mode to the second mode even while the vehicle V is traveling. Thereby, flexible discharge control can be attained in real time in accordance with the situation of the occupant, and the like. This can improve usability of the vehicle V.

Moreover, while the second mode which leads to a longer travelable distance tends to be selected when the change to the second mode is simply accepted, by notifying the occupant of the second information 12 including the third deterioration index 122, the occupant can be led to grasp the degree of deterioration of the secondary battery 9 quantitatively. This can increase the frequency of continuing the first mode, and is advantageous to restraining the performance deterioration of the secondary battery 9.

Moreover, as described using FIG. 10C, the occupant can be notified of the second information 12 at a more appropriate timing while the vehicle V is traveling. This can improve usability of the vehicle V.

It has been recently revealed that the problem of peeling-off as mentioned above is significant when a Si-based active material is used for the active material 93b of the negative electrodes. The configuration as in the present embodiment is particularly effective in the case of using the active material 93b containing Si.

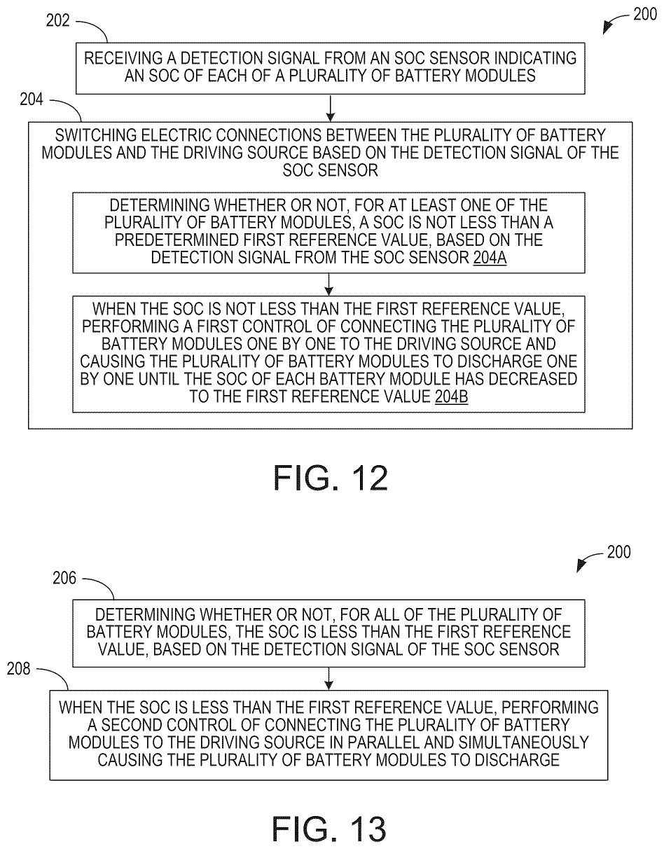

FIGS. 12-18 illustrate flow charts of a method 200 of operating a control apparatus for a secondary battery. Method 200 can be implemented using the vehicle described above or similar vehicle. The secondary battery can include a plurality of battery modules each including one or more battery cells and connected to a driving source of a vehicle. The one or more battery cells each can include a negative electrode including a negative electrode active material, and the control apparatus can be configured to supply electric power to the driving source from the plurality of battery modules.

As shown in FIG. 12, method 200 includes, at 202, receiving a detection signal from an SOC sensor indicating an SOC of each of a plurality of battery modules. At 204, the method includes switching electric connections between the plurality of battery modules and the driving source based on the detection signal of the SOC sensor. The switching is performed at least in part by, at 204A, determining whether or not, for at least one of the plurality of battery modules, a SOC is not less than a predetermined first reference value, based on the detection signal from the SOC sensor, and, at 204B, when the SOC is not less than the first reference value, performing a first control of connecting the plurality of battery modules one by one to the driving source and causing the plurality of battery modules to discharge one by one until the SOC of each battery module has decreased to the first reference value.

As shown in FIG. 13, in method 200 the switching can be further performed by: at 206, determining whether or not, for all of the plurality of battery modules, the SOC is less than the first reference value, based on the detection signal of the SOC sensor, and, at 208, when the SOC is less than the first reference value, performing a second control of connecting the plurality of battery modules to the driving source in parallel and simultaneously causing the plurality of battery modules to discharge.

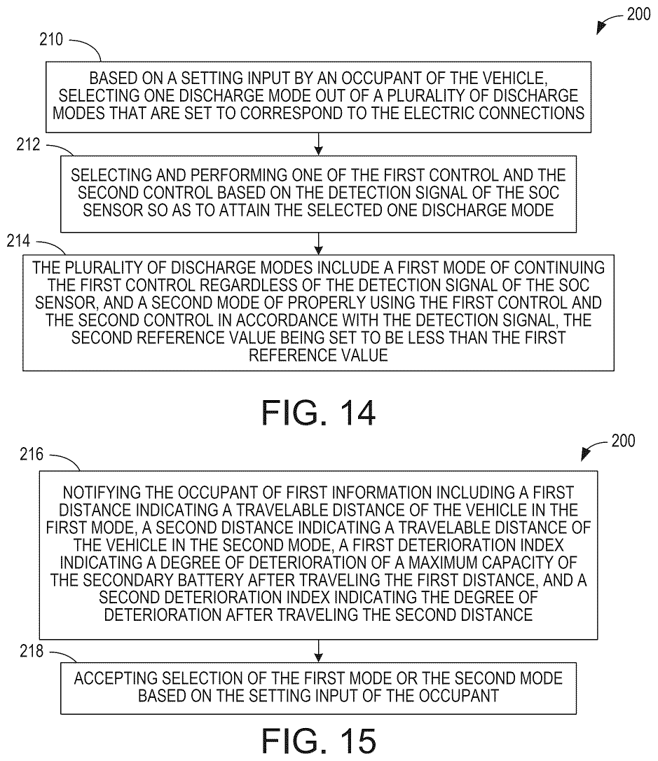

As shown in FIG. 14, the switching can be further performed by: at 210, based on a setting input by an occupant of the vehicle, selecting one discharge mode out of a plurality of discharge modes that are set to correspond to the electric connections, and, at 212, selecting and performing one of the first control and the second control based on the detection signal of the SOC sensor so as to attain the selected one discharge mode. As shown at 214, the plurality of discharge modes can include: a first mode of continuing the first control regardless of the detection signal of the SOC sensor by allowing discharge within an SOC range of which the first reference value is a lower limit, and a second mode of properly using the first control and the second control in accordance with the detection signal of the SOC sensor by allowing discharge within an SOC range of which a second reference value is a lower limit, the second reference value being set to be less than the first reference value.

As shown in FIG. 15, after the driving source is started, the method can further include, at 216, notifying the occupant of first information including a first distance indicating a travelable distance of the vehicle in the first mode, a second distance indicating a travelable distance of the vehicle in the second mode, a first deterioration index indicating a degree of deterioration of a maximum capacity of the secondary battery after traveling the first distance, and a second deterioration index indicating the degree of deterioration after traveling the second distance, and at 218, accepting selection of the first mode or the second mode based on the setting input of the occupant.

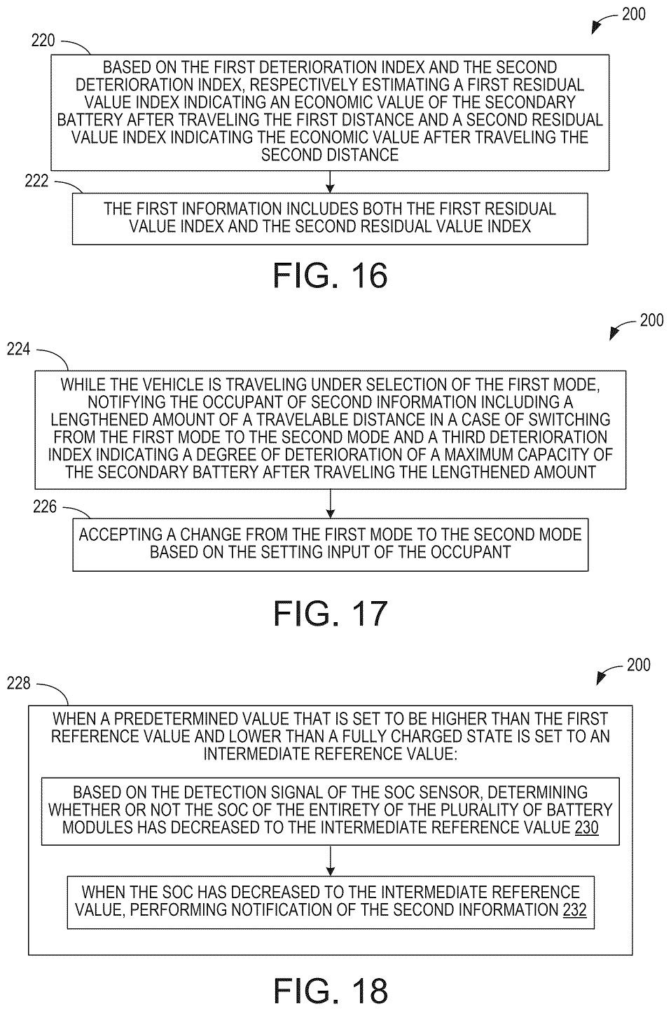

As shown in FIG. 16, the method can include, at 220, based on the first deterioration index and the second deterioration index, respectively estimating a first residual value index indicating an economic value of the secondary battery after traveling the first distance and a second residual value index indicating the economic value after traveling the second distance. As shown at 222, the first information can include both the first residual value index and the second residual value index.

As shown in FIG. 17, the method can include, at 224, while the vehicle is traveling under selection of the first mode: notifying the occupant of second information including a lengthened amount of a travelable distance in a case of switching from the first mode to the second mode and a third deterioration index indicating a degree of deterioration of a maximum capacity of the secondary battery after traveling the lengthened amount. Method 200 can further include, at 226, (also while the vehicle is traveling in the first mode) accepting a change from the first mode to the second mode based on the setting input of the occupant.

As shown in FIG. 18, at 228, when a predetermined value that is set to be higher than the first reference value and lower than a fully charged state is set to an intermediate reference value: the method can include, at 230 based on the detection signal of the SOC sensor, determining whether or not the SOC of the entirety of the plurality of battery modules has decreased to the intermediate reference value, and at 232, when the SOC has decreased to the intermediate reference value, performing notification of the second information.

With method 200, similar technical advantages can be achieved as discussed above are provided by the control apparatus for a secondary battery.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

3 driving source
31 motor
9 secondary battery
90 battery module
91 battery cell
92b negative electrode active material
100 controller
112 mode selection switch
121 SOC sensor
130 notification unit
140 display apparatus
150 touch panel
I1 first information
I11 first distance
I12 second distance
I13 first deterioration index
I14 second deterioration index
I15 first residual value index
I16 second residual value index
I2 second information
I21 lengthened amount (lengthened distance)
I22 third deterioration index
V vehicle

1. A control apparatus for a secondary battery, the secondary battery including a plurality of battery modules each including one or more battery cells and connected to a driving source of a vehicle, the one or more battery cells each having a negative electrode including a negative electrode active material, the control apparatus supplying electric power to the driving source from the plurality of battery modules, the control apparatus comprising:
a state of charge (SOC) sensor that detects a parameter indicating an SOC of each of the plurality of battery modules; and
a controller that switches electric connections between the plurality of battery modules and the driving source based on a detection signal of the SOC sensor, wherein
the controller is configured to:
based on the detection signal of the SOC sensor, determine whether or not, for at least one of the plurality of battery modules, the SOC is not less than a predetermined first reference value, and
when the SOC is not less than the first reference value, perform a first control of connecting the plurality of battery modules one by one to the driving source and causing the plurality of battery modules to discharge one by one until the SOC of each battery module has decreased to the first reference value.

2. The control apparatus according to claim 1, wherein the controller is further configured to:
based on the detection signal of the SOC sensor, determine whether or not, for all of the plurality of battery modules, the SOC is less than the first reference value, and
when the SOC is less than the first reference value, perform a second control of connecting the plurality of battery modules to the driving source in parallel and simultaneously causing the plurality of battery modules to discharge.

3. The control apparatus according to claim 2, wherein
the controller is further configured to:
based on a setting input by an occupant of the vehicle, select one discharge mode out of a plurality of discharge modes that are set to correspond to the electric connections, and
select and perform one of the first control and the second control based on the detection signal of the SOC sensor so as to attain the selected one discharge mode, and
the plurality of discharge modes include:
a first mode of continuing the first control regardless of the detection signal of the SOC sensor by allowing discharge within an SOC range of which the first reference value is a lower limit, and
a second mode of properly using the first control and the second control in accordance with the detection signal of the SOC sensor by allowing discharge within an SOC range of which a second reference value is a lower limit, the second reference value being set to be less than the first reference value.

4. The control apparatus according to claim 3, wherein after the driving source is started, the controller is further configured to:
notify the occupant of first information including a first distance indicating a travelable distance of the vehicle in the first mode, a second distance indicating a travelable distance of the vehicle in the second mode, a first deterioration index indicating a degree of deterioration of a maximum capacity of the secondary battery after traveling the first distance, and a second deterioration index indicating the degree of deterioration after traveling the second distance, and
accept selection of the first mode or the second mode based on the setting input of the occupant.

5. The control apparatus according to claim 4, wherein
based on the first deterioration index and the second deterioration index, the controller is configured to respectively estimate a first residual value index indicating an economic value of the secondary battery after traveling the first distance and a second residual value index indicating the economic value after traveling the second distance, and
the first information includes both the first residual value index and the second residual value index.

6. The control apparatus according to claim 3, wherein while the vehicle is traveling under selection of the first mode, the controller is further configured to:
notify the occupant of second information including a lengthened amount of a travelable distance in a case of switching from the first mode to the second mode and a third deterioration index indicating a degree of deterioration of a maximum capacity of the secondary battery after traveling the lengthened amount, and
accept a change from the first mode to the second mode based on the setting input of the occupant.

7. The control apparatus according to claim 6, wherein
when a predetermined value that is set to be higher than the first reference value and lower than a fully charged state is set to an intermediate reference value, the controller is further configured to:
based on the detection signal of the SOC sensor, determine whether or not the SOC of the entirety of the plurality of battery modules has decreased to the intermediate reference value, and
when the SOC has decreased to the intermediate reference value, perform notification of the second information.

8. The control apparatus for the secondary battery according to claim 7, wherein the negative electrode active material includes Si.

9. The control apparatus according to claim 1, wherein the negative electrode active material includes Si.

10. The control apparatus according to claim 2, wherein the negative electrode active material includes Si.

11. The control apparatus for the secondary battery according to claim 3, wherein the negative electrode active material includes Si.

12. The control apparatus according to claim 4, wherein the negative electrode active material includes Si.

13. The control apparatus according to claim 5, wherein the negative electrode active material includes Si.

14. A method of operating a control apparatus for a secondary battery, the secondary battery including a plurality of battery modules each including one or more battery cells and connected to a driving source of a vehicle, the one or more battery cells each having a negative electrode including a negative electrode active material, the control apparatus being configured to supply electric power to the driving source from the plurality of battery modules, the method comprising:
receiving a detection signal from an SOC sensor indicating an SOC of each of a plurality of battery modules;
switching electric connections between the plurality of battery modules and the driving source based on the detection signal of the SOC sensor, the switching being performed at least in part by:
determining whether or not, for at least one of the plurality of battery modules, a SOC is not less than a predetermined first reference value, based on the detection signal from the SOC sensor, and
when the SOC is not less than the first reference value, performing a first control of connecting the plurality of battery modules one by one to the driving source and causing the plurality of battery modules to discharge one by one until the SOC of each battery module has decreased to the first reference value.

15. The method according to claim 14, wherein the switching is further performed by:
determining whether or not, for all of the plurality of battery modules, the SOC is less than the first reference value, based on the detection signal of the SOC sensor, and
when the SOC is less than the first reference value, performing a second control of connecting the plurality of battery modules to the driving source in parallel and simultaneously causing the plurality of battery modules to discharge.

16. The method according to claim 15, wherein the switching is further performed by:
based on a setting input by an occupant of the vehicle, selecting one discharge mode out of a plurality of discharge modes that are set to correspond to the electric connections, and
selecting and performing one of the first control and the second control based on the detection signal of the SOC sensor so as to attain the selected one discharge mode, wherein
the plurality of discharge modes include:
a first mode of continuing the first control regardless of the detection signal of the SOC sensor by allowing discharge within an SOC range of which the first reference value is a lower limit, and
a second mode of properly using the first control and the second control in accordance with the detection signal of the SOC sensor by allowing discharge within an SOC range of which a second reference value is a lower limit, the second reference value being set to be less than the first reference value.

17. The method according to claim 16, wherein after the driving source is started, the method further comprises:
notifying the occupant of first information including a first distance indicating a travelable distance of the vehicle in the first mode, a second distance indicating a travelable distance of the vehicle in the second mode, a first deterioration index indicating a degree of deterioration of a maximum capacity of the secondary battery after traveling the first distance, and a second deterioration index indicating the degree of deterioration after traveling the second distance, and
accepting selection of the first mode or the second mode based on the setting input of the occupant.

18. The method according to claim 17, further comprising:
based on the first deterioration index and the second deterioration index, respectively estimating a first residual value index indicating an economic value of the secondary battery after traveling the first distance and a second residual value index indicating the economic value after traveling the second distance, wherein
the first information includes both the first residual value index and the second residual value index.

19. The method according to claim 17, further comprising:
while the vehicle is traveling under selection of the first mode:
notifying the occupant of second information including a lengthened amount of a travelable distance in a case of switching from the first mode to the second mode and a third deterioration index indicating a degree of deterioration of a maximum capacity of the secondary battery after traveling the lengthened amount, and
accepting a change from the first mode to the second mode based on the setting input of the occupant.

20. The method according to claim 19, further comprising:
when a predetermined value that is set to be higher than the first reference value and lower than a fully charged state is set to an intermediate reference value:
based on the detection signal of the SOC sensor, determining whether or not the SOC of the entirety of the plurality of battery modules has decreased to the intermediate reference value, and
when the SOC has decreased to the intermediate reference value, performing notification of the second information.
